(19) United States
(12) Patent Application Publication
(10) Pub. No.: US 2009/0094306 A1
(43) Pub. Date: Apr. 9, 2009

(54) CORDIC ROTATION ANGLE CALCULATION

(76) Inventors: Gahn W. Krishnakalin, Austin, TX (US); Emiliano Lozano, Austin, TX (US); Michael P. Potter, Austin, TX (US); Samuel I. Ward, Round Rock, TX (US)

Correspondence Address: IBM CORP (YA);C/O YEE & ASSOCIATES PC, P.O. BOX 802333, DALLAS, TX, 75380, US

(21) Appl. No.: 11/869,029

(22) Filed: Oct. 9, 2007

(51) Int. Cl. G06F 7/38

(52) U.S. Cl. 708/440

(57) ABSTRACT

A computer-implemented method for performing a calculation using a coordinate rotation digital computer (CORDIC) algorithm. A step of the coordinate rotation digital computer algorithm is performed. As a result of performing the step, a value of the coordinate rotation digital computer algorithm is reduced. The value is shifted using a physical adder. A set of bits of the physical adder is disabled, wherein the set of bits corresponds to at least one high order zero of the value.

### BACKGROUND OF THE INVENTION

1. Field of the Invention

The present invention relates generally to an improved data processing system and in particular to devices and methods for performing calculations more efficiently. Still more particularly, the present invention relates to improved techniques for more efficient calculation of coordinate rotation digital computer (CORDIC) algorithm rotation angles.

2. Description of the Related Art

A problem often confronted in computing is how to implement calculation of mathematical functions. Many mathematical functions cannot be calculated directly, but rather numerical techniques are employed to approximate answers to the mathematical function.

One technique for solving mathematical functions on a computer is known as the coordinate rotation digital computer (CORDIC) algorithm. The CORDIC algorithm is an iterative arithmetic algorithm. The CORDIC algorithm is an efficient method for computing many complex mathematical functions, such as, but not limited to, lattice filters, QR factorizations, sine functions, cosine functions, fast Fourier transformations, and, in general, to transcendental functions that cannot be constructed from a finite combination of constant algebraic, exponential, logarithmic functions and field operations. The CORDIC algorithm is commonly used in digital signal processing and in graphical processing.

The basic task performed by the CORDIC algorithm is to rotate a 2 by 1 vector through an angle using a linear, circular, or hyperbolic coordinate system. The CORDIC algorithm rotates the vector through a sequence of elementary angles whose algebraic sum approximates the desired rotation angle. These elementary angles have the property that the vector rotation through elementary angle may be computed easily with a single “shift and add” operation. This formulation of CORDIC algorithm leads to a unified procedure to compute a wide range of complex mathematical functions using a fixed number of shift and add computing steps.

However, angle calculations in the CORDIC algorithm are power inefficient. Power inefficiency arises because, by the end of a computation, the value of the rotation angle is very close to zero. When the rotation angle is very close to zero, high order bits representing high-order zeros are unutilized at small numbers. However, the high order bits are still processed by the data processing system, thereby wasting power.

A high order zero is a zero that is closer to the decimal point of a number. For example, in the number “0.0000552,” any of the first four zeros could be a high order zero. The high order zero corresponds to a bit representing the zero. The bit can be referred to as a high order bit. In contrast, the last number corresponds to a least significant number. The least significant number corresponds to a different bit, which can be considered a least significant bit. The least significant value, “2” in this example, corresponds to a least significant number and hence the least significant bit.

In the original CORDIC algorithm, one of the X, Y, or Z values, though commonly the rotation angle Z, is driven to zero. In standard 2's complement arithmetic, negative one (−1) is represented as all ones and positive one (1) is represented with leading zeros. Thus, as the rotation angle oscillates around the zero plane, a majority of the bits in the computer are switching between one (1) and zero (0). This switching of bits introduces significant unnecessary power consumption in the rotation angle calculation.

### SUMMARY OF THE INVENTION

The illustrative embodiments described herein provide for a computer-implemented method, computer program product, and data processing system for performing a calculation using a coordinate rotation digital computer (CORDIC) algorithm. A step of the coordinate rotation digital computer algorithm is performed. As a result of performing the step, a value of the coordinate rotation digital computer algorithm is reduced. The value is shifted using a physical adder. A set of bits of the physical adder is disabled, wherein the set of bits corresponds to at least one high order zero of the value.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a diagram of a data processing system in accordance with an illustrative embodiment;

FIG. 2 is a table of rotation angles used during an exemplary calculation using the CORDIC algorithm, in accordance with an illustrative embodiment;

FIG. 3 is a block diagram of hardware capable of implementing aspects of the present invention, in accordance with an illustrative embodiment;

FIG. 4 is a flowchart illustrating a method of reducing power consumption while performing a CORDIC algorithm in a data processing system, in accordance with an illustrative embodiment; and

FIG. 5 is a flowchart illustrating a method of reducing power consumption while performing a CORDIC algorithm in a data processing system, in accordance with an illustrative embodiment.

### DETAILED DESCRIPTION OF THE PREFERRED EMBODIMENT

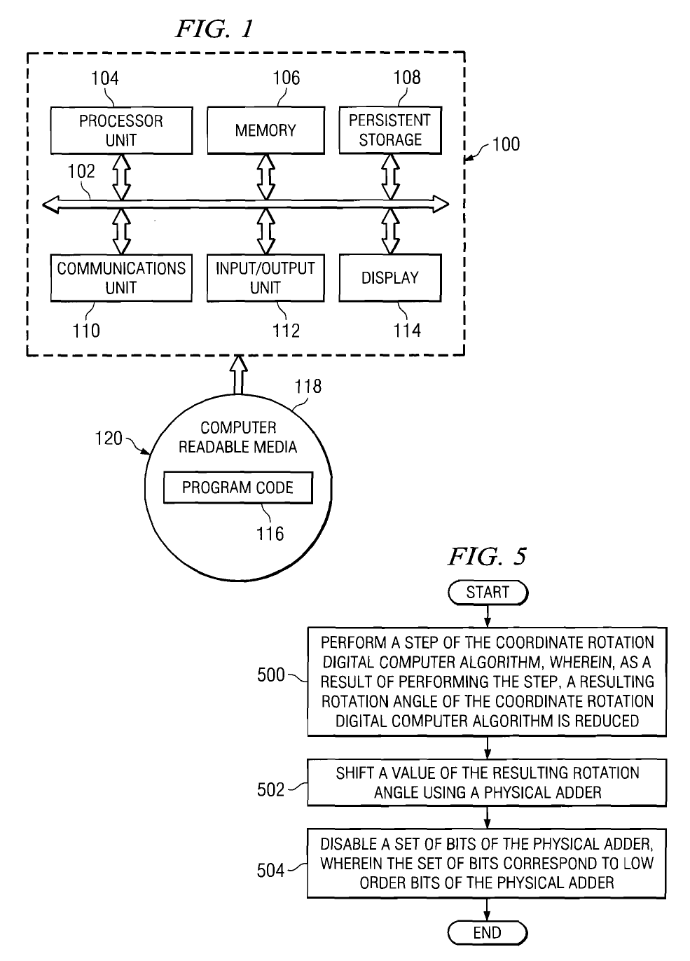

Turning now to FIG. 1, a diagram of a data processing system is depicted in accordance with an illustrative embodiment. In this illustrative example, data processing system 100 includes communications fabric 102, which provides communications between processor unit 104, memory 106, persistent storage 108, communications unit 110, input/output (I/O) unit 112, and display 114.

Processor unit 104 serves to execute instructions for software that may be loaded into memory 106. Processor unit 104 may be a set of one or more processors or may be a multi-processor core, depending on the particular implementation. Further, processor unit 104 may be implemented using one or more heterogeneous processor systems in which a main processor is present with secondary processors on a single chip. As another illustrative example, processor unit 104 may be a symmetric multi-processor system containing multiple processors of the same type.

Memory 106, in these examples, may be, for example, a random access memory. Persistent storage 108 may take various forms depending on the particular implementation. For example, persistent storage 108 may contain one or more components or devices. For example, persistent storage 108 may be a hard drive, a flash memory, a rewritable optical disk, a rewritable magnetic tape, or some combination of the above. The media used by persistent storage 108 also may be removable. For example, a removable hard drive may be used for persistent storage 108.

Communications unit 110, in these examples, provides for communications with other data processing systems or devices. In these examples, communications unit 110 is a network interface card. Communications unit 110 may provide communications through the use of either or both physical and wireless communications links.

Input/output unit 112 allows for input and output of data with other devices that may be connected to data processing system 100. For example, input/output unit 112 may provide a connection for user input through a keyboard and mouse. Further, input/output unit 112 may send output to a printer. Display 114 provides a mechanism to display information to a user.

Instructions for the operating system and applications or programs are located on persistent storage 108. These instructions may be loaded into memory 106 for execution by processor unit 104. The processes of the different embodiments may be performed by processor unit 104 using computer implemented instructions, which may be located in a memory, such as memory 106. These instructions are referred to as, program code, computer usable program code, or computer readable program code that may be read and executed by a processor in processor unit 104. The program code in the different embodiments may be embodied on different physical or tangible computer readable media, such as memory 106 or persistent storage 108.

Program code 116 is located in a functional form on computer readable media 118 and may be loaded onto or transferred to data processing system 100 for execution by processor unit 104. Program code 116 and computer readable media 118 form computer program product 120 in these examples. In one example, computer readable media 118 may be in a tangible form, such as, for example, an optical or magnetic disc that is inserted or placed into a drive or other device that is part of persistent storage 108 for transfer onto a storage device, such as a hard drive that is part of persistent storage 108. In a tangible form, computer readable media 118 also may take the form of a persistent storage, such as a hard drive or a flash memory that is connected to data processing system 100. The tangible form of computer readable media 118 is also referred to as computer recordable storage media.

Alternatively, program code 116 may be transferred to data processing system 100 from computer readable media 118 through a communications link to communications unit 110 and/or through a connection to input/output unit 112. The communications link and/or the connection may be physical or wireless in the illustrative examples. The computer readable media also may take the form of non-tangible media, such as communications links or wireless transmissions containing the program code.

The different components illustrated for data processing system 100 are not meant to provide architectural limitations to the manner in which different embodiments may be implemented. The different illustrative embodiments may be implemented in a data processing system including components in addition to or in place of those illustrated for data processing system 100. Other components shown in FIG. 1 can be varied from the illustrative examples shown.

For example, a bus system may be used to implement communications fabric 102 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 106 or a cache such as found in an interface and memory controller hub that may be present in communications fabric 102.

The illustrative embodiments described herein provide for a computer-implemented method, computer program product, and data processing system for performing a calculation using a coordinate rotation digital computer (CORDIC) algorithm. A step of the coordinate rotation digital computer algorithm is performed. As a result of performing the step, a value of the coordinate rotation digital computer algorithm is reduced. The value is shifted using a physical adder. A set of bits of the physical adder is disabled, wherein the set of bits corresponds to at least one high order zero of the value.

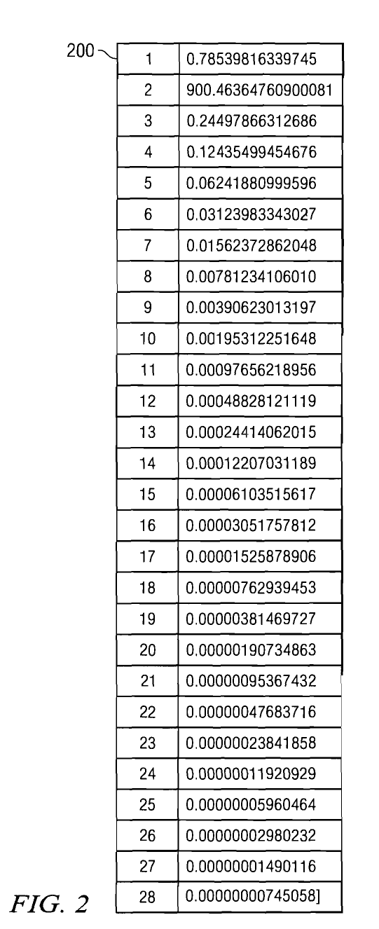

FIG. 2 is a table of rotation angles used during an exemplary calculation using the CORDIC algorithm, in accordance with an illustrative embodiment. The table shown in FIG. 2 can be implemented in a data processing system, such as data processing system 100 shown in FIG. 1.

The left column of table 200 in FIG. 2 shows reference numbers for corresponding rotation angles used during an exemplary computation using a CORDIC algorithm. The right column of FIG. 2 shows the corresponding rotation angles. Each succeeding rotation angle is a new rotation angle used during the iterative CORDIC algorithm.

As can be seen in table 200, the values of the rotation angles become smaller and smaller at each step of the CORDIC algorithm. As the number of iterations of the CORDIC algorithm increase, the value of the corresponding rotation angle approaches a value of zero.

Additionally, the magnitude of the rotation angle decreases. In other words, the full 14 digits of base-10 precision used to represent the initial rotation angle is not necessary at the end of the CORDIC algorithm, as shown at reference numeral 28. As shown in this example, only 8 bits of base-10 precision is used by the final calculation at reference numeral 28.

In the illustrative embodiments described herein, a variable length adder gradually shifts the resulting value of the rotation angle to the left as the rotation angle approaches zero. Additionally, the variable length adder disables high order bits of the adder. As a result, fewer bits in the adder, or in a processor of the data processing system, are used to perform the next CORDIC algorithm.

Using fewer bits to perform a calculation has two primary advantages. First, less power is consumed when performing the calculation. Second, the calculation is performed faster relative to performing the calculation using the precision of the previous rotation angle representation.

In an illustrative example, one lower order bit is disabled at a time. In other words, one zero is accounted-for between succeeding rotation angle shown in FIG. 2. In another illustrative example, more than one bit can be disabled. In other words, multiple zeros can be accounted for between succeeding rotation angles shown in FIG. 2. Alternatively, multiple steps of the CORDIC algorithm can be performed using the same precision or number representation, and then multiple zeros can be accounted-for at a selected future step of the CORDIC algorithm. In an illustrative embodiment, sets of four bits are disabled at any given step of the CORDIC algorithm. Thus, the illustrative embodiments provide for a method of reducing power consumption and increasing processing speed when performing a CORDIC algorithm by reducing the adder width incrementally as the rotation angle in the CORDIC algorithm approaches zero.

In other illustrative embodiments, the illustrative systems and methods can be optimized for particular data processing systems and particular types and ranges of data. For example, if the CORDIC algorithm converges quickly, then more bits can be disabled between succeeding steps. In another example, if the CORDIC algorithm converges slowly, then fewer bits can be disabled between succeeding steps. If desired, one bit can be disabled only after performing multiple steps of the CORDIC algorithm. In yet another example, the presence of specific hardware or software may allow for changes in how and when bits in the adder are disabled during the CORDIC algorithm.

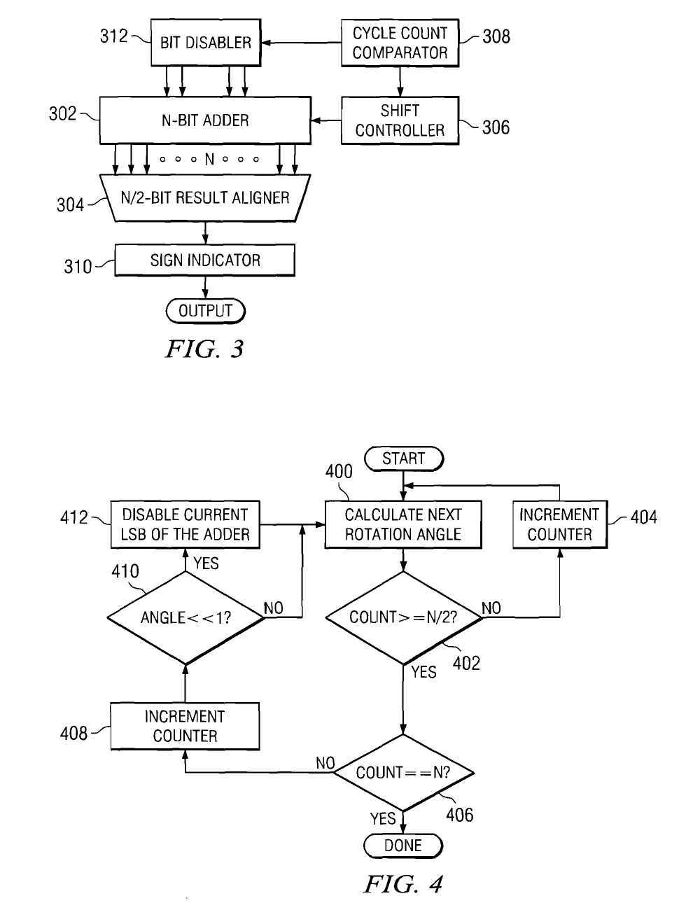

FIG. 3 is a block diagram of hardware capable of implementing aspects of the present invention, in accordance with an illustrative embodiment. Hardware 300 shown in FIG. 3 can be implemented in a data processing system, such as data processing system 100 shown in FIG. 1.

Hardware 300 represents physical hardware, such that each component is a physical, tangible object. Hardware 300 includes N-bit adder 302. N-bit adder 302 performs addition during the CORDIC algorithm. The letter “N” represents a number, such that N-bit adder 302 can represent an adder having any number, N, bits.

Connected to N-bit adder 302 is N/2 bit result aligner 304, shift control 306, and cycle count comparator 308. Together, these hardware components allow hardware 300 to perform a CORDIC algorithm. In turn, signal indicator 310 outputs the result of N/2 bit result aligner. The output of signal indicator 310 also corresponds to a resulting rotation angle of the CORDIC algorithm.

Bit disabler 312 is also connected to N-bit adder 302. Bit disabler 312 can disable one or more bits in N-bit adder 302. Bit disabler 312 can also disable sets of bits in N-bit adder 302. Bit disabler can be used to effectively account-for zeros in rotation angles generated during a CORDIC algorithm.

FIG. 4 is a flowchart illustrating a method of reducing power consumption while performing a CORDIC algorithm in a data processing system, in accordance with an illustrative embodiment. The method shown in FIG. 4 can be implemented in a data processing system, such as data processing system 100 shown in FIG. 1. The method shown in FIG. 4 can be implemented using hardware, such as hardware 300 shown in FIG. 3.

The process begins as the hardware calculates a next rotation angle pursuant to performing a CORDIC algorithm (step 400). The next rotation angle can be a first rotation angle. The hardware then determines whether a count is greater than or equal to N/2 (step 402). N is the size or accuracy of the current operation. Often, N is either 23 or 52 for the IEEE (Institute of Electrical and Electronics Engineers) floating point standards. In other words, N is the precision of the values.

If the count is not greater than or equal to N/2, then the hardware increments the counter (step 404). The process then returns to step 400 and repeats. However, if the count is greater than or equal to N/2 at step 402, then the hardware determines whether the count is equal to N (step 406).

If the count is not equal to N, then the hardware increments the counter (step 408). The hardware then determines if the rotation angle is much, much less than one (step 410). The term “much, much less than” refers to the mathematical term “<<”. In the context of the illustrative embodiments described herein, the term “much, much less than” means that a number has at least one zero to the right of a decimal point.

In any case, if the rotation angle is not much, much less than one, then the process returns to step 400 and repeats. However, if the rotation angle is much, much less than one in step 410, then the hardware disables a current bit of the adder. In an illustrative example, a current bit corresponds to a high-order zero of a number. A high order zero is a zero that is closer to the decimal point of a number. For example, in the number “0.0000552,” any of the first four zeros could be a high order zero. In the illustrative examples, the high order zero corresponds to a bit representing the zero. The bit is known as a high order bit. In contrast, the last number corresponds to a least significant number. The least significant number corresponds to a different bit, which can be considered a least significant bit. The least significant value, “2” corresponds to a least significant number and hence the least significant bit. In any case, the process then returns to step 400 and repeats.

Returning to step 406, if the count is equal to N, then the process terminates. At this point, calculation of the CORDIC algorithm is considered complete.

FIG. 5 is a flowchart illustrating a method of reducing power consumption while performing a CORDIC algorithm in a data processing system, in accordance with an illustrative embodiment. The method shown in FIG. 5 can be implemented in a data processing system, such as data processing system 100 shown in FIG. 1. The method shown in FIG. 5 can be implemented using hardware, such as hardware 300 shown in FIG. 3.

The process begins as the hardware performs a step of the coordinate rotation digital computer algorithm, wherein, as a result of performing the step, a resulting rotation angle of the coordinate rotation digital computer algorithm is reduced (step 500). The processor then shifts a value of the resulting rotation angle using a physical adder (step 502). A physical adder can be N-bit adder 302 in FIG. 3. As used herein, the term “shifting a value” means that a number is represented by fewer digits to the right of a decimal point. Thus, for example, the number “0.000123” can have its value “shifted” to the number “0.123.” Although the number remains the same conceptually, the representation of the number is changed in order to more easily and quickly perform future calculations.

The process continues as the hardware disables a set of bits of the physical adder, wherein the set of bits correspond to high order bits of the physical adder (step 504). By disabling bits in the physical adder, less power is required to perform remaining calculations as fewer bits are used in remaining calculations. Additionally, the speed of performing the CORDIC algorithm increases because fewer bits need to flip to perform a given calculation. In any case, the process terminates thereafter.

The illustrative embodiments described herein have been described with respect to the rotation angle of the CORDIC algorithm. However, the illustrative embodiments can also be implemented with respect to other values of the CORDIC algorithm. Additionally, the illustrative embodiments can be applied to any iterative mathematical process in which not all digits of a number need to be represented at every iteration.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc. In a preferred embodiment, the invention is implemented in hardware. In a specific illustrative embodiment the invention is implemented in a processor or as part of a processor. In another specific illustrative embodiment, the invention is implemented as a separate circuit or chip connected to a bus of a data processing system.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The circuit as described above is part of the design for an integrated circuit chip. The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer-implemented method for performing a calculation using a coordinate rotation digital computer (CORDIC) algorithm, the method comprising the steps of:
performing a step of the coordinate rotation digital computer algorithm, wherein, as a result of performing the step, a value of the coordinate rotation digital computer algorithm is reduced;
shifting the value using a physical adder; and
disabling a set of bits of the physical adder, wherein the set of bits corresponds to at least one high order zero of the value.

2. The computer-implemented method of claim 1 further comprising:
performing a second step of the coordinate rotation digital computer algorithm after disabling the set of bits.

3. The computer-implemented method of claim 1 wherein disabling a set of bits comprises disabling a single bit.

4. The computer-implemented method of claim 1 wherein disabling a set of bits comprises disabling a plurality of bits.

5. The computer-implemented method of claim 1 wherein the value comprises a rotation angle of the coordinate rotation digital computer algorithm.

6. A computer program product comprising:
a computer usable medium having computer usable program code for performing a calculation using a coordinate rotation digital computer (CORDIC) algorithm, the computer program product including:
computer usable program code for performing a step of the coordinate rotation digital computer algorithm, wherein, as a result of performing the step, a value of the coordinate rotation digital computer algorithm is reduced;
computer usable program code for shifting the value using a physical adder; and
computer usable program code for disabling a set of bits of the physical adder, wherein the set of bits corresponds to at least one high order zero of the value.

7. The computer program product of claim 6 further comprising:
computer usable program code for performing a second step of the coordinate rotation digital computer algorithm after disabling the set of bits.

8. The computer program product of claim 6 wherein disabling a set of bits comprises disabling a single bit.

9. The computer program product of claim 6 wherein disabling a set of bits comprises disabling a plurality of bits.

10. The computer program product of claim 6 wherein the value comprises a rotation angle of the coordinate rotation digital computer algorithm.

11. A data processing system comprising:
a bus;
at least one processor coupled to the bus;
a computer usable medium coupled to the bus, wherein the computer usable medium contains a set of instructions for Performing a calculation using a coordinate rotation digital computer (CORDIC) algorithm, wherein the at least one processor is adapted to carry out the set of instructions to:
perform a step of the coordinate rotation digital computer algorithm, wherein, as a result of performing the step, a resulting rotation angle of the coordinate rotation digital computer algorithm is reduced;
shift a value of the resulting rotation angle using a physical adder; and
disable a set of bits of the physical adder, wherein the set of bits corresponds to at least one high order zero of the value.

12. The data processing system of claim 11 further comprising:
perform a second step of the coordinate rotation digital computer algorithm after disabling the set of bits.

13. The data processing system of claim 11 wherein disabling a set of bits comprises disabling a single bit.

14. The data processing system of claim 11 wherein disabling a set of bits comprises disabling a plurality of bits.

15. The data processing system of claim 11 wherein the value comprises a rotation angle of the coordinate rotation digital computer algorithm.
